(19) United States
(12) Patent Application Publication
(10) Pub. No.: US 2011/0134167 A1
(43) Pub. Date: Jun. 9, 2011

(54) DISPLAY DEVICE AND ELECTRIC APPARATUS USING THE SAME

(76) Inventor: Keiichi Yamamoto, Osaka (JP)

(21) Appl. No.: 13/057,360

(22) PCT Filed: May 13, 2009
(86) PCT No.: PCT/JP2009/058911

§ 371 Date: Feb. 3, 2011

(30) Foreign Application Priority Data
Aug. 5, 2008 (JP) 2008-202179

(51) Int. Cl. G09G 3/36; G09G 5/02

(52) U.S. Cl. 345/690; 345/88

(57) ABSTRACT

A display device (10) includes an upper substrate (first substrate) (2), a lower substrate (second substrate) (3), and a conductive liquid (16) that is sealed in a display space (S) formed between the upper substrate (2) and the lower substrate (3) so as to be moved toward an effective display region (P1) or a non-effective display region (P2). The amount of voltage applied to at least one selected from a signal electrode (4) and both of a reference electrode (5) and a scanning electrode (6) within a predetermined period is changed when an H voltage (first voltage) is applied to the reference electrode (5) and when an L voltage (second voltage) is applied to the reference electrode (5).

### TECHNICAL FIELD

The present invention relates to a display device that displays information such as images and characters by moving a conductive liquid, and an electric apparatus using the display device.

### BACKGROUND ART

In recent years, as typified by an electrowetting type display device, a display device that displays information by utilizing a transfer phenomenon of a conductive liquid due to an external electric field has been developed and put to practical use.

Specifically, such a conventional display device includes first and second substrates, a transparent water as a conductive liquid, and an oil colored with a predetermined color, and further the conductive liquid and the oil are sealed in a display space formed between the first and second substrates (see, e.g., Patent Document 1). The conventional display device also includes a counter electrode provided on the first substrate side, and an address electrode and a retain electrode provided on the second substrate side. In the conventional display device, two voltages selected from 0 V, a voltage at + potential higher than 0V, and a voltage at ++ potential higher than the voltage at + potential are applied to the counter electrode, the address electrode, and the retain electrode, thereby moving the conductive liquid toward the address electrode (non-effective display region) or the retain electrode (effective display region) so as to change the display color.

### Prior Art Documents

### Patent Documents

Patent Document 1: JP 2006-519412 A

### DISCLOSURE OF THE INVENTION

### Problem to be Solved by the Invention

However, the above conventional display device does not consider that the speed of movement of the conductive liquid varies due to differences in polarity between the voltages applied to the three electrodes. Therefore, the conventional display device has a problem of not being able to prevent degradation of the display quality caused by the variation in the speed of movement of the conductive liquid.

With the foregoing in mind, it is an object of the present invention to provide a display device that can prevent degradation of the display quality caused by a variation in the speed of movement of the conductive liquid due to differences in polarity between the applied voltages, and an electric apparatus using the display device.

### Means for Solving Problem

To achieve the above object, a display device of the present invention includes the following: a first substrate provided on a display surface side; a second substrate provided on a non-display surface side of the first substrate so that a predetermined display space is formed between the first substrate and the second substrate; an effective display region and a non-effective display region that are defined with respect to the display space; and a conductive liquid sealed in the display space so as to be moved toward the effective display region or the non-effective display region. The display device is capable of changing a display color on the display surface side by moving the conductive liquid. The display device includes the following: a signal electrode that is placed in the display space so as to come into contact with the conductive liquid; a reference electrode that is provided on one of the first substrate and the second substrate so as to be electrically insulated from the conductive liquid and to be located on one of the effective display region side and the non-effective display region side; and a scanning electrode that is provided on one of the first substrate and the second substrate so as to be electrically insulated from the conductive liquid and the reference electrode and to be located on the other of the effective display region side and the non-effective display region side. The reference electrode is configured so that a first voltage or a second voltage can be applied thereto. The scanning electrode is configured so that the first voltage or the second voltage can be applied thereto, and when one of the first voltage and the second voltage is applied to the reference electrode, the other voltage is applied to the scanning electrode. The amount of voltage applied to at least one selected from the signal electrode and both of the reference electrode and the scanning electrode within a predetermined period is changed when the first voltage is applied to the reference electrode and when the second voltage is applied to the reference electrode.

In the above display device, the amount of the voltage applied to at least one selected from the signal electrode and both of the reference electrode and the scanning electrode within the predetermined period is changed when the first voltage is applied to the reference electrode and when the second voltage is applied to the reference electrode. This configuration can prevent a variation in the speed of movement of the conductive liquid due to difference in polarity of the applied voltages to the signal electrode with respect to the reference electrode or the scanning electrode. Consequently, unlike the above conventional example, the display device can prevent degradation of the display quality caused by the variation in the speed of movement of the conductive liquid.

In the above display device, it is preferable that a plurality of the signal electrodes are provided along a predetermined arrangement direction, and a plurality of the reference electrodes and a plurality of the scanning electrodes are alternately arranged so as to intersect with the plurality of the signal electrodes. It is also preferable that the display device includes the following: a signal voltage application portion that is connected to the plurality of the signal electrodes and applies a signal voltage in the predetermined voltage range to each of the signal electrodes in accordance with information to be displayed on the display surface side; a reference voltage application portion that is connected to the plurality of the reference electrodes and applies one of a selected voltage and a non-selected voltage to each of the reference electrodes, the selected voltage allowing the conductive liquid to move in the display space in accordance with the signal voltage and the non-selected voltage inhibiting a movement of the conductive liquid in the display space; and a scanning voltage application portion that is connected to the plurality of the scanning electrodes and applies one of a selected voltage and a non-selected voltage to each of the scanning electrodes, the selected voltage allowing the conductive liquid to move in the display space in accordance with the signal voltage the non-selected voltage inhibiting a movement of the conductive liquid in the display space.

In this case, a matrix-driven display device with excellent display quality can be provided.

In the above display device, it is preferable that magnitude of the voltage applied to at least one selected from the signal electrode and both of the reference electrode and the scanning electrode within the predetermined period is changed so that a potential difference between the signal electrode and the reference electrode or between the signal electrode and the scanning electrode when the first voltage is applied to the reference electrode differs from a potential difference between the signal electrode and the reference electrode or between the signal electrode and the scanning electrode when the second voltage is applied to the reference electrode.

In this case, the magnitude of the voltage applied to at least one selected from the signal electrode and both of the reference electrode and the scanning electrode within the predetermined period is changed, so that the amount of the applied voltage is changed, thereby preventing degradation of the display quality caused by the variation in the speed of movement of the conductive liquid.

In the above display device, it is preferable that the magnitude of the voltage applied to the signal electrode within the predetermined period is changed so that a potential difference between the signal electrode and the reference electrode or between the signal electrode and the scanning electrode when the first voltage is applied to the reference electrode differs from a potential difference between the signal electrode and the reference electrode or between the signal electrode and the scanning electrode when the second voltage is applied to the reference electrode.

In this case, compared to the case where the voltages applied to the reference electrode and the scanning electrode are changed, it can be easier to change the amount of the applied voltage and to simplify the control of the display device.

In the above display device, it is preferable that an application time of the voltage applied to the signal electrode within the predetermined period is changed when the first voltage is applied to the reference electrode and when the second voltage is applied to the reference electrode.

In this case, the application time of the voltage applied to the signal electrode within the predetermined period is changed, so that the amount of the applied voltage is changed, thereby preventing degradation of the display quality caused by the variation in the speed of movement of the conductive liquid.

In the above display device, a plurality of pixel regions may be provided on the display surface side, the plurality of the pixel regions may be located at each of the intersections of the signal electrodes and the scanning electrodes, and the display space in each of the pixel regions may be partitioned by a partition.

In this case, the display color on the display surface side can be changed for each pixel by moving the conductive liquid in each of the pixels on the display surface side.

In the above display device, the plurality of the pixel regions may be provided in accordance with a plurality of colors that enable full-color display to be shown on the display surface side.

In this case, the color image display can be performed by moving the corresponding conductive liquid properly in each of the pixels.

In the above display device, it is preferable that an insulating fluid that is not mixed with the conductive liquid is movably sealed in the display space.

In this case, the speed of movement of the conductive liquid can be easily improved.

In the above display device, it is preferable that a dielectric layer is formed on the surfaces of the reference electrode and the scanning electrode.

In this case, the dielectric layer reliably increases the electric field applied to the conductive liquid, so that the speed of movement of the conductive liquid can be more easily improved.

In the above display device, the non-effective display region may be defined by a light-shielding layer that is provided on one of the first substrate and the second substrate, and the effective display region may be defined by an aperture formed in the light-shielding layer.

In this case, the effective display region and the non-effective display region can be properly and reliably defined with respect to the display space.

An electric apparatus of the present invention includes a display portion that displays information including characters and images. The display portion includes any of the above display devices.

In the electric apparatus having the above configuration, the display portion uses the display device that can prevent degradation of the display quality caused by the variation in the speed of movement of the conductive liquid due to differences in polarity between the applied voltages. Thus, a high-performance electric apparatus that includes the display portion with excellent display quality can be easily provided.

### Effects of the Invention

The present invention can provide a display device that can prevent degradation of the display quality caused by the variation in the speed of movement of the conductive liquid due to differences in polarity between the applied voltages, and an electric apparatus using the display device.

### BRIEF DESCRIPTION OF DRAWINGS

FIG. 1 is plan view for explaining a display device and an image display apparatus of Embodiment 1 of the present invention.

FIG. 2 is an enlarged plan view showing the main configuration of the upper substrate in FIG. 1 when viewed from a display surface side.

FIG. 3 is an enlarged plan view showing the main configuration of the lower substrate in FIG. 1 when viewed from a non-display surface side.

FIGS. 4A and 4B are cross-sectional views showing the main configuration of the display device in FIG. 1 during non-CF color display and CF color display, respectively.

FIG. 5 is a diagram for explaining an operation example of the image display apparatus.

FIG. 6 is a waveform diagram showing specific voltages applied to signal electrodes, reference electrodes, and scanning electrodes, as shown in FIG. 1.

FIG. 7 includes graphs showing the relationship between the applied voltage and the movement time when the potential of the signal electrode with respect to the reference electrode has a positive polarity and a negative polarity, respectively.

FIG. 8 is a waveform diagram showing specific voltages applied to the signal electrodes, the reference electrodes, and the scanning electrodes in a modified example of the above display device.

FIG. 9 is a plan view for explaining a display device and an image display apparatus of Embodiment 2 of the present invention.

FIG. 10 is a diagram for explaining an operation example of the display device shown in FIG. 9. FIGS. 10(a) to 10(h) are diagrams for explaining the relationship between the movement distance of the conductive liquid and the applied voltage to the signal electrode.

FIG. 11 is a diagram for explaining another operation example of the display device shown in FIG. 9. FIGS. 11(a) to 11(f) are diagrams for explaining the relationship between the movement distance of the conductive liquid and the applied voltage to the signal electrode.

FIG. 12 is a diagram for explaining an operation example in a modified example of the display device shown in FIG. 9. FIGS. 12(a) to 12(f) are diagrams for explaining the relationship between the movement distance of the conductive liquid and the applied voltage to the signal electrode.

FIG. 13 is a diagram for explaining an operation example in another modified example of the display device shown in FIG. 9. FIGS. 13(a) to 13(f) are diagrams for explaining the relationship between the movement distance of the conductive liquid and the applied voltage to the signal electrode.

### DESCRIPTION OF THE INVENTION

Hereinafter, preferred embodiments of a display device and an electric apparatus of the present invention will be described with reference to the drawings. In the following description, the present invention is applied to an image display apparatus including a display portion that can display color images. The size and size ratio of each of the constituent members in the drawings do not exactly reflect those of the actual constituent members.

### Embodiment 1

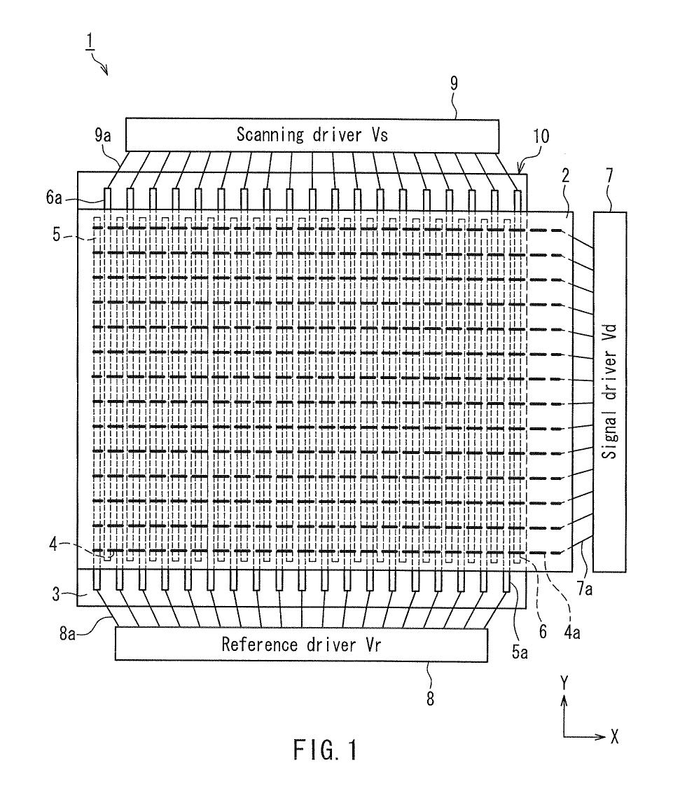

FIG. 1 is a plan view for explaining a display device and an image display apparatus of Embodiment 1 of the present invention. In FIG. 1, an image display apparatus 1 of this embodiment includes a display portion using a display device 10 of the present invention. The display portion has a rectangular display surface. The display device 10 includes an upper substrate 2 and a lower substrate 3 that are arranged to overlap each other in the direction perpendicular to the sheet of FIG. 1. The overlap between the upper substrate 2 and the lower substrate 3 forms an effective display region of the display surface (as will be described in detail later).

In the display device 10, a plurality of signal electrodes 4 are spaced at predetermined intervals and arranged in stripes in the X direction. Moreover, in the display device 10, a plurality of reference electrodes 5 and a plurality of scanning electrodes 6 are alternately arranged in stripes in the Y direction. The signal electrodes 4 intersect with the reference electrodes 5 and the scanning electrodes 6, and a plurality of pixel regions are located at each of the intersections of the signal electrodes 4 and the scanning electrodes 6.

The signal electrodes 4, the reference electrodes 5, and the scanning electrodes 6 are configured so that voltages can be independently applied to these electrodes. In the reference electrodes 5, a High voltage (referred to as “H voltage” in the following) that serves as a first voltage or a Low voltage (referred to as “L voltage” in the following) that serves as a second voltage can be applied, and a voltage in the predetermined voltage range between the H voltage and the L voltage can be applied. Similarly, in the scanning electrodes 6, the H voltage or the L voltage can be applied, and a voltage in the predetermined voltage range between the H voltage and the L voltage can be applied. Moreover, when one of the H voltage and the L voltage is being applied to the reference electrodes 5, the other voltage is applied to the scanning electrodes 6 (as will be described in detail later).

In the signal electrodes 4, a voltage in the predetermined voltage range between an Hd voltage lower than the H voltage and an Ld voltage lower than the L voltage is applied in accordance with information to be displayed on the display surface. The H voltage, the L voltage, the rid voltage, and the Ld voltage are set to values that can prevent a variation in the speed of movement of a conductive liquid due to differences in polarity between the applied voltages, as will be described in detail later.

In the display device 10, the pixel regions are separated from one another by partitions and provided in accordance with a plurality of colors that enable full-color display to be shown on the display surface, as will be described in detail later. The display device 10 changes the display color on the display surface by moving the conductive liquid (as will be described later) for each of a plurality of pixels (display cells) arranged in a matrix using an electrowetting phenomenon.

One end of the signal electrodes 4, the reference electrodes 5, and the scanning electrodes 6 are extended to the outside of the effective display region of the display surface and form terminals 4a, 5a, and 6a, respectively.

A signal driver 7 is connected to the individual terminals 4a of the signal electrodes 4 via wires 7a. The signal driver 7 constitutes a signal voltage application portion and applies a signal voltage Vd to each of the signal electrodes 4 in accordance with information when the image display apparatus 1 displays the information including characters and images on the display surface.

A reference driver 8 is connected to the individual terminals 5a of the reference electrodes 5 via wires 8a. The reference driver 8 constitutes a reference voltage application portion and applies a reference voltage Vr to each of the reference electrodes 5 when the image display apparatus 1 displays the information including characters and images on the display surface.

A scanning driver 9 is connected to the individual terminals 6a of the scanning electrodes 6 via wires 9a. The scanning driver 9 constitutes a scanning voltage application portion and applies a scanning voltage Vs to each of the scanning electrodes 6 when the image display apparatus 1 displays the information including characters and images on the display surface.

The scanning driver 9 applies either a non-selected voltage or a selected voltage to each of the scanning electrodes 6 as the scanning voltage Vs. The non-selected voltage inhibits the movement of the conductive liquid and the selected voltage allows the conductive liquid to move in accordance with the signal voltage Vd. Moreover, the reference driver 8 is operated with reference to the operation of the scanning driver 9. The reference driver 8 applies either the non-selected voltage that inhibits the movement of the conductive liquid or the selected voltage that allows the conductive liquid to move in accordance with the signal voltage Vd to each of the reference electrodes 5 as the reference voltage Vr.

In the image display apparatus 1, the scanning driver 9 applies the selected voltage to each of the scanning electrodes 6 in sequence, e.g., from the left to the right of FIG. 1, and the reference driver 8 applies the selected voltage to each of the reference electrodes 5 in sequence from the left to the right of FIG. 1 in synchronization with the operation of the scanning driver 9. Thus, the scanning driver 9 and the reference driver 8 perform their respective scanning operations for each line (as will be described in detail later).

The signal driver 7, the reference driver 8, and the scanning driver 9 include a direct-current power supply or an alternating-current power supply that supplies the signal voltage Vd, the reference voltage Vr, and the scanning voltage Vs, respectively.

The reference driver 8 switches the polarity of the reference voltage Vr at predetermined time intervals (e.g., 1 frame). Moreover, the scanning driver 9 switches the polarity of the scanning voltage Vs in accordance with the switching of the polarity of the reference voltage Vr. Thus, since the polarities of the reference voltage Vr and the scanning voltage Vs are switched at predetermined time intervals, the localization of charges in the reference electrodes 5 and the scanning electrodes 6 can be prevented, compared to the case where the voltages with the same polarity are always applied to the reference electrodes 5 and the scanning electrodes 6. Moreover, it is possible to prevent the adverse effects of a display failure (after-image phenomenon (image burn-in)) and low reliability (a reduction in life) due to the localization of charges.

Moreover, in the signal driver 7, the reference driver 8, and the scanning driver 9, the magnitude of the voltage applied to the signal electrodes 4 within a predetermined period (i.e., a selected period given by the above scanning operations) is changed so that a potential difference between the signal electrodes 4 and the reference electrode 5 or between the signal electrodes 4 and the scanning electrode 6 when the H voltage (first voltage) is applied to the reference electrode 5 differs from a potential difference between the signal electrodes 4 and the reference electrode 5 or between the signal electrodes 4 and the scanning electrode 6 when the L voltage (second voltage) is applied to the reference electrode 5, as will be described in detail later.

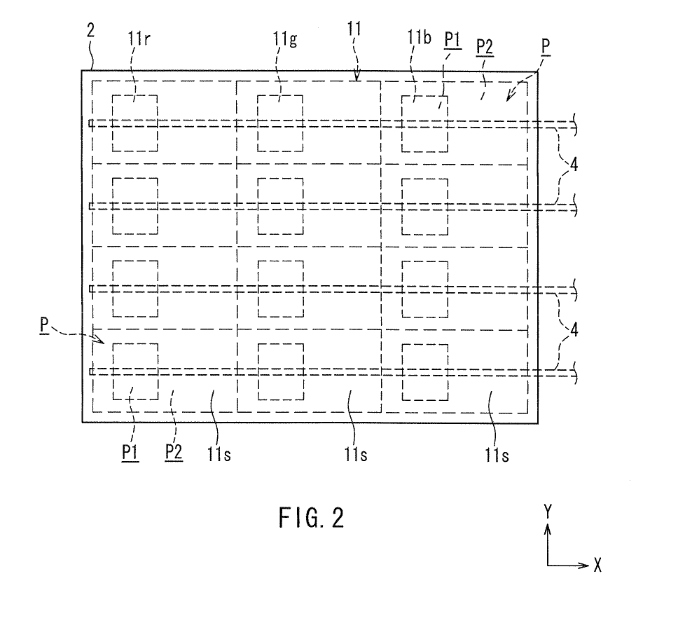

The pixel structure of the display device 10 will be described in detail with reference to FIGS. 2 to 4 as well as FIG. 1.

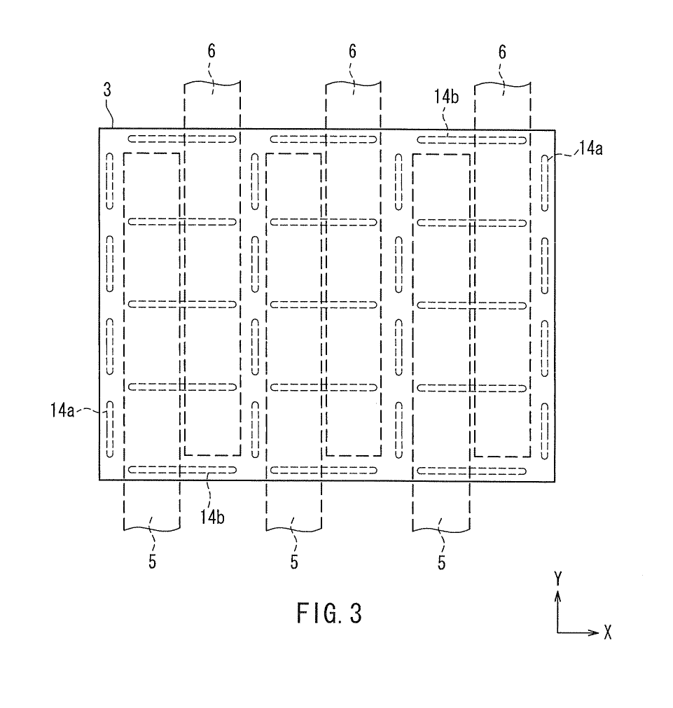

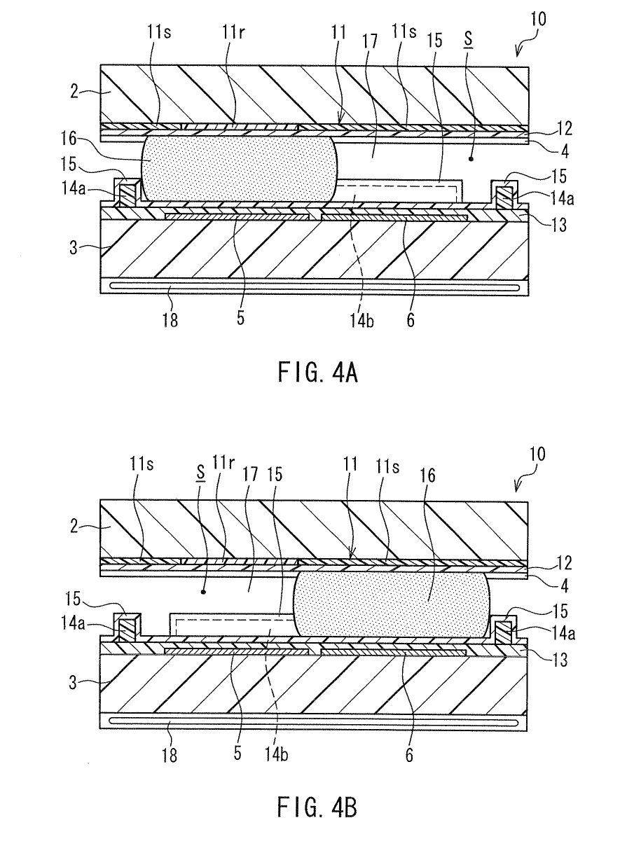

FIG. 2 is an enlarged plan view showing the main configuration of the upper substrate in FIG. 1 when viewed from the display surface side. FIG. 3 is an enlarged plan view showing the main configuration of the lower substrate in FIG. 1 when viewed from the non-display surface side. FIGS. 4A and 4B are cross-sectional views showing the main configuration of the display device in FIG. 1 during non-CF color display and CF color display, respectively. For the sake of simplification, FIGS. 2 and 3 show twelve pixels placed at the upper left corner of the plurality of pixels on the display surface in FIG. 1.

In FIGS. 2 to 4, the display device 10 includes the upper substrate 2 that is provided on the display surface side and serves as a first substrate, and the lower substrate 3 that is provided on the back (i.e., the non-display surface side) of the upper substrate 2 and serves as a second substrate. In the display device 10, the upper substrate 2 and the lower substrate 3 are located at a predetermined distance away from each other, so that a predetermined display space S is formed between the upper substrate 2 and the lower substrate 3. The conductive liquid 16 and an insulating oil 17 that is not mixed with the conductive liquid 16 are sealed in the display space S and can be moved in the X direction (the lateral direction of FIG. 4). The conductive liquid 16 can be moved toward an effective display region P1 or a non-effective display region P2, as will be described later.

The conductive liquid 16 can be, e.g., an aqueous solution including water as a solvent and a predetermined electrolyte as a solute. Specifically, 1 mmol/L of potassium chloride (KCl) aqueous solution may be used as the conductive liquid 16. Moreover, the conductive liquid 16 is colored black with a pigment or dye.

The conductive liquid 16 is colored black and therefore functions as a shutter that allows or prevents light transmission. When the conductive liquid 16 is slidably moved in the display space S toward the reference electrode 5 (i.e., the effective display region P1) or the scanning electrode 6 (i.e., the non-effective display region P2), the display color of each pixel of the display device 10 is changed to black or any color of RBG, as will be described in detail later.

The oil 17 can be, e.g., a nonpolar, colorless, and transparent oil including one or more than one selected from a side-chain higher alcohol, a side-chain higher fatty acid, an alkane hydrocarbon, a silicone oil, and a matching oil. The oil 17 is shifted in the display space S as the conductive liquid 16 is slidably moved.

The upper substrate 2 can be, e.g., a transparent glass material such as a non-alkali glass substrate or a transparent sheet material such as a transparent synthetic resin (e.g., an acrylic resin). A color filter layer 11 and a hydrophobic film 12 are formed in this order on the surface of the upper substrate 2 that faces the non-display surface side. Moreover, the signal electrodes 4 are provided on the hydrophobic film 12.

Like the upper substrate 2, the lower substrate 3 can be, e.g., a transparent glass material such as a non-alkali glass substrate or a transparent sheet material such as a transparent synthetic resin (e.g., an acrylic resin). The reference electrodes 5 and the scanning electrodes 6 are provided on the surface of the lower substrate 3 that faces the display surface side. Moreover, a dielectric layer 13 is formed to cover the reference electrodes 5 and the scanning electrodes 6. Ribs 14a and 14b are formed parallel to the Y direction and the X direction, respectively, on the surface of the dielectric layer 13 that faces the display surface side. In the lower substrate 3, a hydrophobic film 15 is further formed to cover the dielectric layer 13 and the ribs 14a, 14b.

A backlight 18 that emits, e.g., white illumination light is integrally attached to the back (i.e., the non-display surface side) of the lower substrate 3, thus providing a transmission type display device 10.

The color filter layer 11 includes red (R), green (G), and blue (B) color filters 11r, 11g, and 11b and a black matrix 11s serving as a light-shielding layer, thereby constituting the pixels of R, G, and B colors. In the color filter layer 11, as shown in FIG. 2, the R, G, and B color filters 11r, 11g, and 11b are successively arranged in columns in the X direction, and each column includes four color filters in the Y direction. Thus, a total of twelve pixels are arranged in three columns (the X direction) and four rows (the Y direction).

As shown in FIG. 2, in each of the pixel regions P of the display device 10, any of the R, G, and B color filters 11r, 11g, and 11b is provided in a portion corresponding to the effective display region P1 and the black matrix 11s is provided in a portion corresponding to the non-effective display region P2 of the pixel. In other words, with respect to the display space S, the non-effective display region (non-aperture region) P2 is defined by the black matrix (light-shielding layer) 11s and the effective display region P1 is defined by an aperture (i.e., any of the color filters 11r, 11g, and 11b) formed in that black matrix 11s.

In the display device 10, the area of each of the color filters 11r, 11g, and 11b is the same as or slightly larger than that of the effective display region P1. On the other hand, the area of the black matrix 11s is the same as or slightly smaller than that of the non-effective display region P2. In FIG. 2, the boundary between two black matrixes 11s corresponding to the adjacent pixels is indicated by a dotted line to clarify the boundary between the adjacent pixels. Actually, however, no boundary is present between the black matrixes 11s of the color filter layer 11.

In the display device 10, the display space S is divided into the pixel regions P by the ribs 14a, 14b serving as the partitions as described above. Specifically, as shown in FIG. 3, the display space S of each pixel is partitioned by two opposing ribs 14a and two opposing ribs 14b. Moreover, in the display device 10, the ribs 14a, 14b prevent the conductive liquid 16 from flowing into the display space S of the adjacent pixel regions P. The ribs 14a, 14b are made of, e.g., a light-curing resin, and the height of the ribs 14a, 14b protruding from the dielectric layer 13 is determined so as to prevent the flow of the conductive liquid 16 between the adjacent pixels.

Other than the above description, e.g., frame-shaped ribs may be formed for each pixel on the lower substrate 3 instead of the ribs 14a, 14b. Moreover, the top of the frame-shaped ribs may be brought into close contact with the upper substrate 2 so that the adjacent pixel regions P are hermetically separated from one another. When the top of the ribs comes into close contact with the upper substrate 2, the signal electrodes 4 are provided to penetrate the ribs, and thus can be placed in the display space S.

The hydrophobic films 12, 15 are made of, e.g., a transparent synthetic resin, and preferably a fluoro polymer that functions as a hydrophilic layer for the conductive liquid 16 when a voltage is applied. This can significantly change the wettability (contact angle) between the conductive liquid 16 and each of the surfaces of the upper and lower substrates 2, 3 that face the display space S. Thus, the speed of movement of the conductive liquid 16 can be improved. The dielectric layer 13 can be, e.g., a transparent dielectric film containing parylene, a silicon nitride, a hafnium oxide, a zinc oxide, a titanium dioxide, or an aluminum oxide.

The reference electrodes 5 and the scanning electrodes 6 are made of, e.g., transparent electrode materials such as indium oxides (ITO), tin oxides (SnO₂), and zinc oxides (AZO, GZO, or IZO). The reference electrodes 5 and the scanning electrodes 6 are formed in stripes on the lower substrate 3 by a known film forming method such as sputtering.

The signal electrodes 4 can be, e.g., linear wiring that is arranged parallel to the X direction. The signal electrodes 4 are placed on the hydrophobic film 12 so as to extend substantially through the center of each of the pixel regions P in the Y direction, and further to come into direct contact with the conductive liquid 16 by passing through the conductive liquid 16. This can improve the responsibility of the conductive liquid 16 during a display operation.

A transparent hydrophobic film (not shown) made of, e.g., a fluoro polymer is formed on the surfaces of the signal electrodes 4 and allows the conductive liquid 16 to move smoothly. This hydrophobic film does not electrically insulate the signal electrodes 4 from the conductive liquid 16, and therefore not interfere with the improvement in responsibility of the conductive liquid 16.

Other than the above description, the color filter layer 11, the signal electrodes 4, and the hydrophobic film 12 may be formed in this order on the surface of the upper substrate 2 that faces the non-display surface side.

A material that is electrochemically inert to the conductive liquid 16 is used for the signal electrodes 4. Therefore, even if the signal voltage Vd is applied to the signal electrodes 4, the electrochemical reaction between the signal electrodes 4 and the conductive liquid 16 can be minimized. Thus, it is possible to prevent electrolysis of the signal electrodes 4 and to improve the reliability and life of the display device 10.

Specifically, the signal electrodes 4 are made of, e.g., an electrode material including at least one of gold, silver, copper, platinum, and palladium. The signal electrodes 4 may be formed by fixing thin wires made of the above metal material on the color filter layer 11 or by mounting an ink material such as a conductive paste containing the metal material on the color filter layer 11 with screen printing or the like.

The shape of the signal electrode 4 is determined using the transmittance of the reference electrode 5 located below the effective display region P1 of the pixel. Specifically, based on a transmittance of about 75% to 95% of the reference electrode 5, the shape of the signal electrode 4 is determined so that the occupation area of the signal electrode 4 on the effective display region P1 is 30% or less, preferably 10% or less, and more preferably 5% or less of the area of the effective display region P1.

In each pixel of the display device 10 having the above configuration, as shown in FIG. 4A, when the conductive liquid 16 is held between the color filter 11r and the reference electrode 5, light from the backlight 18 is blocked by the conductive liquid 16, so that the black display (non-CF color display) is performed. On the other hand, as shown in FIG. 4B, when the conductive liquid 16 is held between the black matrix 11s and the scanning electrode 6, light from the backlight 18 is not blocked by the conductive liquid 16 and passes through the color filter 11r, so that the red display (CF color display) is performed.

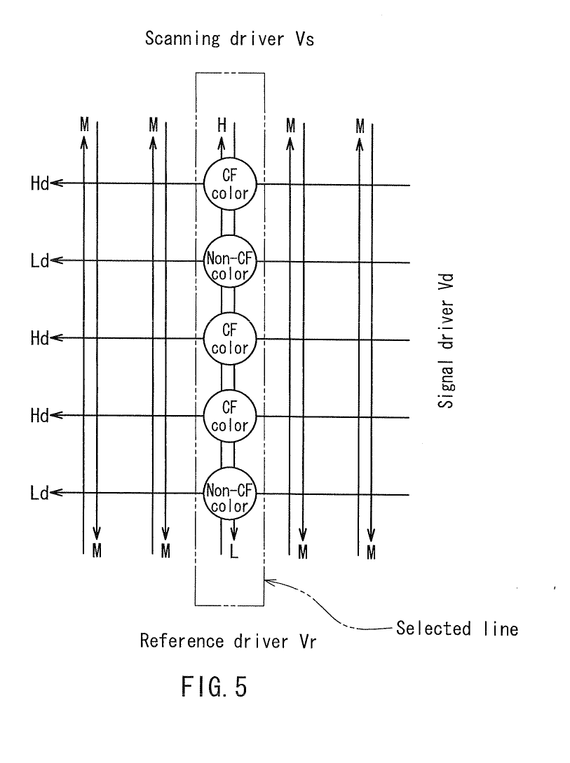

Hereinafter, a display operation of the image display apparatus 1 of this embodiment having the above configuration will be described in detail with reference to FIGS. 5 to 7 as well as FIGS. 1 to 4.

Referring to FIG. 5, first, the basic operation of the image display apparatus 1 will be described.

FIG. 5 is a diagram for explaining an operation example of the image display apparatus 1.

In FIG. 5, the reference driver 8 and the scanning driver 9 apply the selected voltages (i.e., the reference voltage Vr and the scanning voltage Vs) to the reference electrodes 5 and the scanning electrodes 6 in sequence in a predetermined scanning direction, e.g., from the left to the right of FIG. 5, respectively. Specifically, the reference driver 8 and the scanning driver 9 perform their scanning operations to determine a selected line by applying the H voltage (first voltage) and the L voltage (second voltage) as the selected voltages to the reference electrodes 5 and the scanning electrodes 6 in sequence, respectively. In this selected line, the signal driver 7 applies the Hd or Ld voltage (i.e., the signal voltage Vd) to the corresponding signal electrodes 4 in accordance with the external image input signal. Thus, in each of the pixels of the selected line, the conductive liquid 16 is moved toward the effective display region P1 or the non-effective display region P2, and the display color on the display surface is changed accordingly.

On the other hand, the reference driver 8 and the scanning driver 9 apply the non-selected voltages (i.e., the reference voltage Vr and the scanning voltage Vs) to non-selected lines, namely to all the remaining reference electrodes 5 and scanning electrodes 6, respectively. Specifically, the reference driver 8 and the scanning driver 9 apply, e.g., Middle voltages (referred to as “M voltage” in the following) having an intermediate voltage value between the H voltage and the L voltage as the non-selected voltages to all the remaining reference electrodes 5 and scanning electrodes 6, respectively. Thus, in each of the pixels of the non-selected lines, the conductive liquid 16 stands still without unnecessary displacement from the effective display region P1 or the non-effective display region P2, and the display color on the display surface is unchanged.

Table 1 shows the combinations of the voltages applied to the reference electrodes 5, the scanning electrodes 6, and the signal electrodes 4 in the above display operation. As shown in Table 1, the behavior of the conductive liquid 16 and the display color on the display surface depend on the applied voltages. In Table 1, the H voltage, the L voltage, the M voltage, the Hd voltage, and the Ld voltage are abbreviated to “H”, “L”, “M”, “Hd”, and “Ld”, respectively (the same is true for Tables 2 to 4 in the following). The specific values of the H voltage, the L voltage, the M voltage, the Hd voltage, and the Ld voltage are, e.g., +7.5 V, −7.5 V, 0 V +6.5 V, and −8.5 V, respectively.

TABLE I

| | Reference | Scanning | Signal | Behavior of conductive liquid and |
|---|---|---|---|---|
| | electrode | electrode | electrode | display color on display surface |
| Selected line | H | L | Hd | The conductive liquid is moved toward |
| | | | | the scanning electrode. |
| | | | | CF color display |
| | | | Ld | The conductive liquid is moved toward |
| | | | | the reference electrode. |
| | | | | Black display |
| Non-selected | M | M | Hd | The conductive liquid is still (not moving). |
| line | | | Ld | Black or CF color display |

<Selected Line Operation>

In the selected line, e.g., when the Hd voltage is applied to the signal electrodes 4, since the H voltage is applied to the reference electrode 5 and the L voltage is applied to the scanning electrode 6, a potential difference between the scanning electrode 6 and the signal electrodes 4 is 14 V (=|−7.5−6.5|), and a potential difference between the reference electrode 5 and the signal electrodes 4 is 1 V (=|7.5−6.5|). Therefore, the conductive liquid 16 is moved in the display space S toward the scanning electrode 6 that makes a large potential difference from the signal electrodes 4. Consequently, the conductive liquid 16 has been moved toward the non-effective display region P2, as shown in FIG. 4B, and allows the illumination light emitted from the backlight 18 to reach the color filter 11r by shifting the oil 17 toward the reference electrode 5. Thus, the display color on the display surface becomes red display (i.e., the CF color display) due to the color filter 11r. In the image display apparatus 1, when the CF color display is performed in all the three adjacent R, G, and B pixels as a result of the movement of the conductive liquid 16 toward the non-effective display region P2, the red, green, and blue colors of light from the corresponding R, G, and B pixels are mixed into white light, resulting in the white display.

In the selected line, when the Ld voltage is applied to the signal electrodes 4, a potential difference between the scanning electrode 6 and the signal electrodes 4 is 1 V (=|−7.5+8.5|), and a potential difference between the reference electrode 5 and the signal electrodes 4 is 16 V (=|7.5+8.5|). Therefore, the conductive liquid 16 is moved in the display space S toward the reference electrode 5 that makes a large potential difference from the signal electrodes 4. Consequently, the conductive liquid 16 has been moved toward the effective display region P1, as shown in FIG. 4A, and prevents the illumination light emitted from the backlight 18 from reaching the color filter 11r. Thus, the display color on the display surface becomes black display (i.e., the non-CF color display) due to the presence of the conductive liquid 16.

<Non-Selected Line Operation>

In the non-selected lines, e.g., when the Hd voltage is applied to the signal electrodes 4, the conductive liquid 16 stands still in the same position, and the current display color is maintained. Since the M voltages are applied to both the reference electrodes 5 and the scanning electrodes 6, a potential difference between the reference electrodes 5 and the signal electrodes 4 is the same as a potential difference between the scanning electrodes 6 and the signal electrodes 4. Consequently, the display color is maintained without changing from the black display or the CF color display in the current state.

Similarly, in the non-selected lines, even when the Ld voltage is applied to the signal electrodes 4, the conductive liquid 16 stands still in the same position, and the current display color is maintained. Since the M voltages are applied to both the reference electrodes 5 and the scanning electrodes 6, a potential difference between the reference electrodes 5 and the signal electrodes 4 is the same as a potential difference between the scanning electrodes 6 and the signal electrodes 4.

As described above, in the non-selected lines, the conductive liquid 16 is not moved, but stands still and the display color on the display surface is unchanged regardless of whether the Hd or Ld voltage is applied to the signal electrodes 4.

On the other hand, in the selected line, the conductive liquid 16 can be moved in accordance with the voltage applied to the signal electrodes 4, as described above, and the display color on the display surface can be changed accordingly.

In the image display apparatus 1, depending on the combinations of the applied voltages in Table 1, the display color of each pixel on the selected line can be, e.g., the CF colors (red, green, or blue) produced by the color filters 11r, 11g, and 11b or the non-CF color (black) due to the conductive liquid 16 in accordance with the voltage applied to the signal electrodes 4 corresponding to the individual pixels, as shown in FIG. 5. When the reference driver 8 and the scanning driver 9 determine a selected line of the reference electrode 5 and the scanning electrode 6 by performing their scanning operations, e.g., from the left to the right of FIG. 5, the display colors of the pixels in the display portion of the image display apparatus 1 also are changed in sequence from the left to the right of FIG. 5. Therefore, if the reference driver 8 and the scanning driver 9 perform the scanning operations at a high speed, the display colors of the pixels in the display portion of the image display apparatus 1 also can be changed at a high speed. Moreover, by applying the signal voltage Vd to the signal electrodes 4 in synchronization with the scanning operation for the selected line, the image display apparatus 1 can display various information including dynamic images based on the external image input signal.

The combinations of the voltages applied to the reference electrodes 5, the scanning electrodes 6, and the signal electrodes 4 are not limited to Table 1, and may be as shown in Table 2.

TABLE 2

| | Reference | Scanning | Signal | Behavior of conductive liquid and |
|---|---|---|---|---|
| | electrode | electrode | electrode | display color on display surface |
| Selected line | L | H | Ld | The conductive liquid is moved toward |
| | | | | the scanning electrode. |
| | | | | CF color display |
| | | | Hd | The conductive liquid is moved toward |
| | | | | the reference electrode. |
| | | | | Black display |
| Non-selected | M | M | Hd | The conductive liquid is still (not moving). |
| line | | | Ld | Black or CF color display |

The reference driver 8 and the scanning driver 9 perform their scanning operations to determine a selected line by applying the L voltage (second voltage) and the H voltage (first voltage) as the selected voltages to the reference electrodes 5 and the scanning electrodes 6 in sequence in a predetermined scanning direction, e.g., from the left to the right of FIG. 5, respectively. In this selected line, the signal driver 7 applies the Hd or Ld voltage (i.e., the signal voltage Vd) to the corresponding signal electrodes 4 in accordance with the external image input signal.

On the other hand, the reference driver 8 and the scanning driver 9 apply the M voltages as the non-selected voltages to the non-selected lines, namely to all the remaining reference electrodes 5 and scanning electrodes 6.

<Selected Line Operation>

In the selected line, e.g., when the Ld voltage is applied to the signal electrodes 4, since the L voltage is applied to the reference electrode 5 and the H voltage is applied to the scanning electrode 6, a potential difference between the scanning electrode 6 and the signal electrodes 4 is 16 V (=|7.5+8.5|), and a potential difference between the reference electrode 5 and the signal electrodes 4 is 1 V (=|−7.5+8.5|). Therefore, the conductive liquid 16 is moved in the display space S toward the scanning electrode 6 that makes a large potential difference from the signal electrodes 4. Consequently, the conductive liquid 16 has been moved toward the non-effective display region P2, as shown in FIG. 4B, and allows the illumination light emitted from the backlight 18 to reach the color filter 11r by shifting the oil 17 toward the reference electrode 5. Thus, the display color on the display surface becomes red display (i.e., the CF color display) due to the color filter 11r. Like Table 1, when the CF color display is performed in all the three adjacent R, G, and B pixels, the white display is performed.

In the selected line, when the Hd voltage is applied to the signal electrodes 4, a potential difference between the scanning electrode 6 and the signal electrodes 4 is 1 V (=|7.5−6.5|), and a potential difference between the reference electrode 5 and the signal electrodes 4 is 14 V (=|−7.5−6.5|). Therefore, the conductive liquid 16 is moved in the display space S toward the reference electrode 5 that makes a large potential difference from the signal electrodes 4. Consequently, the conductive liquid 16 has been moved toward the effective display region P1, as shown in FIG. 4A, and prevents the illumination light emitted from the backlight 18 from reaching the color filter 11r. Thus, the display color on the display surface becomes black display (i.e., the non-CF color display) due to the presence of the conductive liquid 16.

<Non-Selected Line Operation>

In the non-selected lines, e.g., when the Ld voltage is applied to the signal electrodes 4, the conductive liquid 16 stands still in the same position, and the current display color is maintained. Since the M voltages are applied to both the reference electrodes 5 and the scanning electrodes 6, a potential difference between the reference electrodes 5 and the signal electrodes 4 is the same as a potential difference between the scanning electrodes 6 and the signal electrodes 4. Consequently, the display color is maintained without changing from the black display or the CF color display in the current state.

Similarly, in the non-selected lines, even when the Hd voltage is applied to the signal electrodes 4, the conductive liquid 16 stands still in the same position, and the current display color is maintained. Since the M voltages are applied to both the reference electrodes 5 and the scanning electrodes 6, a potential difference between the reference electrodes 5 and the signal electrodes 4 is the same as a potential difference between the scanning electrodes 6 and the signal electrodes 4.

In the non-selected lines, as shown in Table 2, similarly to Table 1, the conductive liquid 16 is not moved, but stands still and the display color on the display surface is unchanged regardless of whether the Hd or Ld voltage is applied to the signal electrodes 4.

On the other hand, in the selected line, the conductive liquid 16 can be moved in accordance with the voltage applied to the signal electrodes 4, as described above, and the display color on the display surface can be changed accordingly.

In the image display apparatus 1 of this embodiment, other than the combinations of the applied voltages shown in Tables 1 and 2, the applied voltages to the signal electrodes 4 may be not only two values of the Hd voltage and the Ld voltage, but also a voltage between the Hd voltage and the Ld voltage that is changed in accordance with information to be displayed on the display surface. In other words, the image display apparatus 1 can perform halftone display by controlling the signal voltage Vd. Thus, the display device 10 can have excellent display performance.

In this embodiment, as described above, the reference driver 8 and the scanning driver 9 switch the polarities of the reference voltage Vr and the scanning voltage Vs, e.g., at each frame, respectively. In this embodiment, the operations shown in Tables 1 and 2 are alternately performed per frame. Accordingly, the polarity of each of the reference voltage Vr and the scanning voltage Vs is reversed per frame, so that the occurrence of image burn-in or the like should be prevented as much as possible.

Moreover, in this embodiment, as described above, in the signal driver 7, the reference driver 8, and the scanning driver 9, the magnitude of the voltage applied to the signal electrodes 4 within a predetermined period (i.e., a selected period given by the above scanning operations) is changed so that a potential difference between the signal electrodes 4 and the reference electrode 5 or between the signal electrodes 4 and the scanning electrode 6 when the H voltage (first voltage) is applied to the reference electrode 5 differs from a potential difference between the signal electrodes 4 and the reference electrode 5 or between the signal electrodes 4 and the scanning electrode 6 when the L voltage (second voltage) is applied to the reference electrode 5. Thus, this embodiment can prevent a variation in the speed of movement of the conductive liquid 16 due to differences in polarity between the applied voltages.

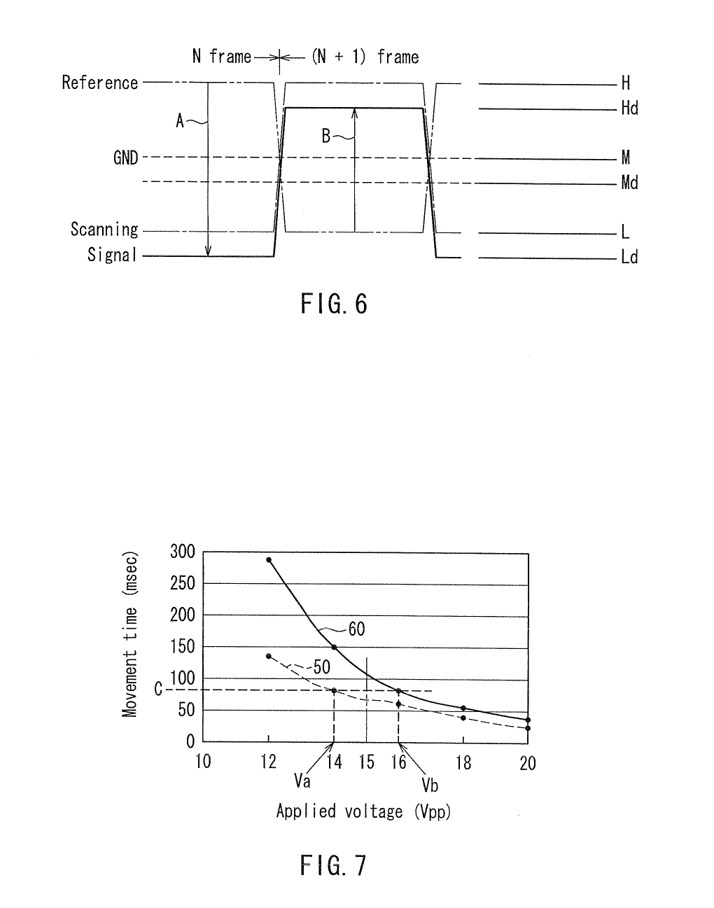

Hereinafter, the movement (behavior) of the conductive liquid 16 in any of the pixels will be described in detail with reference to FIGS. 6 and 7.

FIG. 6 is a waveform diagram showing specific voltages applied to the signal electrodes, the reference electrodes, and the scanning electrodes, as shown in FIG. 1. FIG. 7 includes graphs showing the relationship between the applied voltage and the movement time when the potential of the signal electrode with respect to the reference electrode has a positive polarity and a negative polarity, respectively.

As shown in FIG. 6, in any of the pixels of this embodiment, the applied voltages to the signal electrodes 4 in N (N is an integer of 1 or more) frame and (N+1) frame are the Ld voltage and the Hd voltage, respectively, as represented by a solid line. The applied voltages to the reference electrode 5 in the N frame and the (N+1) frame are the H voltage and the L voltage, respectively, as represented by an alternate long and two short dashes line. The applied voltage to the scanning electrode 6 in the N frame and the (N+1) frame are the L voltage and the H voltage, respectively, as represented by an alternate long and short dash line. In FIG. 6, the “Md” voltage is an intermediate voltage between the Hd voltage and the Ld voltage and is lower (−1 V) than the M voltage at 0 potential (GND).

As indicated by the arrow A in FIG. 6, a potential difference between the reference electrode 5 and the signal electrodes 4 is 16 V (=|7.5+8.5|) in the N frame. On the other hand, as indicated by the arrow B in FIG. 6, a potential difference between the reference electrode 5 and the signal electrodes 4 is 14 V (=|−7.5−6.5|) in the (N+1) frame. Accordingly, in the case of FIG. 6, the Ld voltage and the Hd voltage, which have been changed from the reference voltages, i.e., the L voltage and the H voltage, are applied to the signal electrodes 4 so that a potential difference between the signal electrodes 4 and the reference electrode 5 occurs when the H voltage (first voltage) is applied to the reference electrode 5 and when the L voltage (second voltage) is applied to the reference electrode 5.

For the actual pixels, the scanning operations are performed, as shown in FIG. 5. Therefore, in any of the pixels of the non-selected lines after the scanning operations, the M voltages are applied to the reference electrodes 5 and the scanning electrodes 6, as shown in Tables 1 and 2. Then, in any of the pixels, the Hd voltage or the Ld voltage is applied in accordance with information to be displayed during the scanning operations in the next frame. At this time, as shown in FIG. 6, the polarity of the applied voltage to the signal electrodes 4 with respect to the reference electrode 5 differs between the N frame and the (N+1) frame when the black display is performed as a result of the movement of the conductive liquid 16 from the scanning electrode 6 toward the reference electrode 5.

In the N frame of FIG. 6, since the Ld voltage is applied to the signal electrodes 4, the polarity of the applied voltage to the signal electrodes 4 with respect to the reference electrode 5 is a negative polarity. On the other hand, in the (N+1) frame of FIG. 6, since the Hd voltage is applied to the signal electrodes 4, the polarity of the applied voltage to the signal electrodes 4 with respect to the reference electrode 5 is a positive polarity. Thus, the speed of movement of the conductive liquid 16 varies depending on the polarity with respect to the reference electrode 5 to which the conductive liquid 16 is moved.

Specifically, the results of the experiments conducted by the present inventors showed that when the polarity of the applied voltage to the signal electrodes 4 with respect to the reference electrode 5 is a positive polarity, the conductive liquid 16 is moved as indicated by a curve 50 in FIG. 7, and that when the polarity of the applied voltage to the signal electrodes 4 with respect to the reference electrode 5 is a negative polarity, the conductive liquid 16 is moved as indicated by a curve 60 in FIG. 7. As indicated by the curves 50 and 60, the time it takes for the conductive liquid 16 to move a unit distance by the applied voltage (i.e., the speed of movement) varies depending on the polarity difference. The speed of movement is lower and the conductive liquid 16 is moved slower in the negative polarity than in the positive polarity.

In other words, if the voltages are applied to the reference electrode 5 and the signal electrodes 4 so that a potential difference of, e.g., 15 V occurs between the reference electrode 5 and the signal electrodes 4, a reciprocal of the speed of movement of the conductive liquid 16 is about 70 [mS/unit distance] when the above polarity is a positive polarity, as derived from the curve 50. On the other hand, if the voltages are applied to the reference electrode 5 and the signal electrodes 4 so that the same potential difference of 15 V occurs between the reference electrode 5 and the signal electrodes 4, a reciprocal of the speed of movement of the conductive liquid 16 is about 110 [mS/unit distance] when the above polarity is a negative polarity, as derived from the curve 60. Thus, the speed of movement of the conductive liquid 16 significantly varies depending on the polarity difference. In the N frame and the (N+1) frame of FIG. 6, similarly to the applied voltages to the reference electrode 5, if the L voltage or the H voltage is applied to the signal electrodes 4, a potential difference between the reference electrode 5 and the signal electrodes 4 will be 15 V in both the N frame and the (N+1) frame. Therefore, the speed of movement of the conductive liquid 16 varies, and the behavior of this conductive liquid 16 also varies, leading to degradation of the display quality.

In this embodiment, as shown in FIG. 7, an applied voltage Va in the positive polarity and an applied voltage Vb in the negative polarity at the same movement time C are obtained from the corresponding curves 50 and 60. That is, the applied voltages Va and Vb are determined as 14V and 16V, respectively. Then, when the reference voltages of the H voltage and the L voltage, i.e., the applied voltages to the reference electrode 5 are set to ±7.5 V, the applied voltage to the signal electrodes 4 may be shifted only by 1 V (=(Vb−Va)/2). Thus, the Hd voltage may be 6.5 V (=7.5−1) and the Ld voltage may be −8.5 V (=−7.5−1). Consequently, the speed of movement of the conductive liquid 16 is the same in both the N frame (i.e., the above polarity is the negative polarity) and the (N+1) frame (i.e., the above polarity is the positive polarity), and the behavior of this conductive liquid 16 also can be the same.

In the above description, the conductive liquid 16 is moved toward the reference electrode 5. However, the conductive liquid 16 is moved toward the scanning electrode 6 in the same manner as the movement toward the reference electrode 5. When the polarity of the applied voltage to the signal electrodes 4 with respect to the scanning electrode 6 is a positive polarity, the conductive liquid 16 is moved as indicated by the curve 50 in FIG. 7. On the other hand, when the polarity of the applied voltage to the signal electrodes 4 with respect to the scanning electrode 6 is a negative polarity, the conductive liquid 16 is moved as indicated by the curve 60 in FIG. 7. Therefore, the Hd voltage or the Ld voltage is applied to the signal electrodes 4 so that a potential difference between the signal electrodes 4 and the scanning electrode 6 when the H voltage (first voltage) is applied to the scanning electrode 6 (the reference electrode 5) differs from a potential difference between the signal electrodes 4 and the scanning electrode 6 when the L voltage (second voltage) is applied to the scanning electrode 6 (the reference electrode 5). Thus, the speed of movement and behavior of the conductive liquid 16 toward the scanning electrode 6 can be the same regardless of the polarity of the applied voltage to the signal electrodes 4 with respect to the scanning electrode 6.

In the display device 10 of this embodiment having the above configuration, the magnitude of the voltage applied to the signal electrodes 4 within a predetermined period is changed so that a potential difference between the signal electrodes 4 and the reference electrode 5 or between the signal electrodes 4 and the scanning electrode 6 when the H voltage (first voltage) is applied to the reference electrode 5 differs from a potential difference between the signal electrodes 4 and the reference electrode 5 or between the signal electrodes 4 and the scanning electrode 6 when the L voltage (second voltage) is applied to the reference electrode 5. Thus, the display device 10 of this embodiment can prevent a variation in the speed of movement of the conductive liquid 16 due to differences in polarity of the applied voltages to the signal electrodes 4 with respect to the reference electrode 5 or the scanning electrode 6. Consequently, unlike the conventional example, the display device 10 of this embodiment can prevent degradation of the display quality caused by the variation in the speed of movement of the conductive liquid 16.

In the image display apparatus (electric apparatus) 1 of this embodiment, the display device 10 is used in the display portion. Therefore, it is possible to easily provide the image display apparatus 1 including a display portion with excellent display quality.

In the display device 10 of this embodiment, the plurality of reference electrodes 5 and the plurality of scanning electrodes 6 are alternately arranged on the lower substrate 3 so as to intersect with the plurality of signal electrodes 4. Moreover, in the display device 10 of this embodiment, the signal driver (signal voltage application portion) 7, the reference driver (reference voltage application portion) 8, and the scanning driver (scanning voltage application portion) 9 apply the signal voltage Vd, the reference voltage Vr, and the scanning voltage Vs to the signal electrodes 4, the reference electrodes 5, and the scanning electrodes 6, respectively. Thus, this embodiment can provide the matrix-driven display device 10 with excellent display quality.

### Modified Example of Embodiment 1

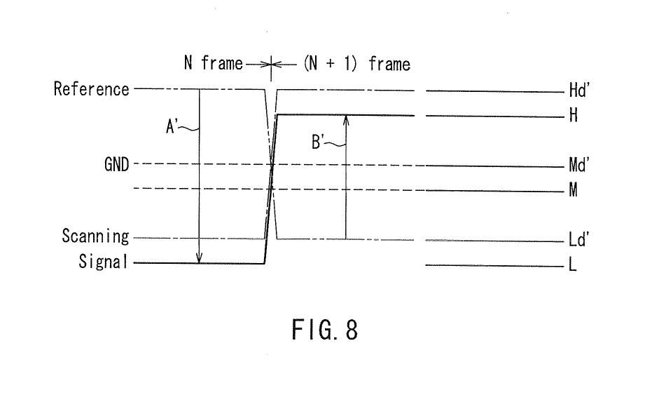

FIG. 8 is a waveform diagram showing specific voltages applied to the signal electrodes, the reference electrodes, and the scanning electrodes in a modified example of the above display device. In FIG. 8, the modified example mainly differs from Embodiment 1 in that the magnitude of the voltages applied to the reference electrodes and the scanning electrodes are changed instead of the magnitude of the voltage applied to the signal electrodes. The same components as those of Embodiment 1 are denoted by the same reference numerals, and the explanation will not be repeated.

As shown in FIG. 8, in the modified example, the applied voltages to the signal electrodes 4 in the N frame and the (N+1) frame are the L voltage and the H voltage, respectively, as represented by a solid line. The applied voltages to the reference electrode 5 in the N frame and the (N+1) frame are an Hd′ voltage (first voltage) and an Ld′ voltage (second voltage), respectively, as represented by an alternate long and two short dashes line. The applied voltage to the scanning electrode 6 in the N frame and the (N+1) frame are the Ld′ voltage and the Hd′ voltage, respectively, as represented by an alternate long and short dash line.

In the modified example, similarly to Embodiment 1, the magnitude of the voltage applied to the signal electrodes 4 within a predetermined period (i.e., a selected period given by the above scanning operations) is changed so that a potential difference between the signal electrodes 4 and the reference electrode 5 or between the signal electrodes 4 and the scanning electrode 6 when the Hd′ voltage (first voltage) is applied to the reference electrode 5 differs from a potential difference between the signal electrodes 4 and the reference electrode 5 or between the signal electrodes 4 and the scanning electrode 6 when the Ld′ voltage (second voltage) is applied to the reference electrode 5. As shown in FIG. 8, the voltages are applied so that the potential differences between the reference electrode 5 and the signal electrodes 4 are represented by A′ and B′ in the N frame and the (N+1) frame, respectively.

In the modified example, similarly to Embodiment 1, the Hd′ voltage, the Ld′ voltage, the H voltage, and the L voltage are set to values that can prevent a variation in the speed of movement of the conductive liquid 16 due to differences in polarity between the applied voltages. Specifically, the Hd′ voltage, the Ld′ voltage, the H voltage, and the L voltage are set to, e.g., 8.5 V, −6.5 V, 7.5 V, and −7.5 V, respectively. In FIG. 8, the “Md” voltage is an intermediate voltage between the Hd′ voltage and the Ld′ voltage and is higher (1 V) than the M voltage at 0 potential (GND).

With the above configuration, the modified example can have the effects comparable to those of Embodiment 1.

Other than the above description, Embodiment 1 may be combined with the modified example. That is, the magnitude of the voltages applied to the signal electrodes and both of the reference electrode and the scanning electrode within the predetermined period may be changed so that a potential difference between the signal electrodes and the reference electrode or between the signal electrodes and the scanning electrode when the H voltage (first voltage) is applied to the reference electrode differs from a potential difference between the signal electrodes and the reference electrode or between the signal electrodes and the scanning electrode when the L voltage (second voltage) is applied to the reference electrode.

However, compared to the case where the voltages applied to the reference electrode and the scanning electrode are changed, a change in magnitude of the voltage applied to the signal electrodes is preferred because it can be easier to change the amount of the applied voltage and to simplify the control of the display device.

### Embodiment 2

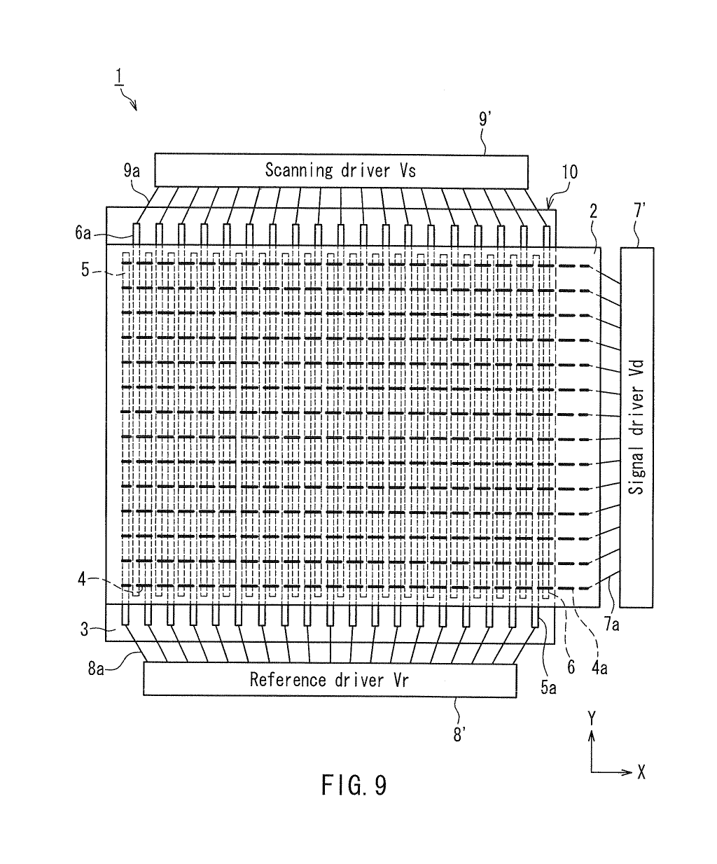

FIG. 9 is a plan view for explaining a display device and an image display apparatus of Embodiment 2 of the present invention. In FIG. 9, this embodiment mainly differs from Embodiment 1 in that an application time of the voltage applied to the signal electrodes within a predetermined period is changed when the H voltage (first voltage) is applied to the reference electrode and when the L voltage (second voltage) is applied to the reference electrode. The same components as those of Embodiment 1 are denoted by the same reference numerals, and the explanation will not be repeated.

As shown in FIG. 9, in this embodiment, a signal driver 7′, a reference driver 8′, and a scanning driver 9′ are provided. The signal driver 7′, the reference driver 8′, and the scanning driver 9′ apply the signal voltage Vd, the reference voltage Vr, and the scanning voltage Vs to the signal electrodes 4, the reference electrodes 5, and the scanning electrodes 6, respectively. In this embodiment, unlike Embodiment 1, the signal driver 7′ applies the H voltage (first voltage) or the L voltage (second voltage).

Specifically, in this embodiment, the signal driver 7′, the reference driver 8′, and the scanning driver 9′ apply the voltages shown in Tables 3 and 4 alternately per frame to the corresponding signal electrodes 4, the reference electrodes 5, and the scanning electrodes 6, respectively. In this embodiment, similarly to Embodiment 1, the black display or the CF color display is performed by moving the conductive liquid 16 toward the reference electrode 5 or the scanning electrode 6.

TABLE 3

| | Reference | Scanning | Signal | Behavior of conductive liquid and |
|---|---|---|---|---|
| | electrode | electrode | electrode | display color on display surface |
| Selected line | H | L | H | The conductive liquid is moved toward |
| | | | | the scanning electrode. |
| | | | | CF color display |
| | | | L | The conductive liquid is moved toward |
| | | | | the reference electrode. |
| | | | | Black display |
| Non-selected | M | M | H | The conductive liquid is still (not moving). |
| line | | | L | Black or CF color display |

TABLE 4

| | Reference | Scanning | Signal | Behavior of conductive liquid and |
|---|---|---|---|---|
| | electrode | electrode | electrode | display color on display surface |
| Selected line | L | H | L | The conductive liquid is moved toward |
| | | | | the scanning electrode. |
| | | | | CF color display |
| | | | H | The conductive liquid is moved toward |
| | | | | the reference electrode. |
| | | | | Black display |
| Non-selected | M | M | H | The conductive liquid is still (not moving). |
| line | | | L | Black or CF color display |

In this embodiment, the application time of the voltage applied to the signal electrodes 4 within a selected period given by the scanning operations (i.e., a predetermined period) is changed when the H voltage (first voltage) is applied to the reference electrode 5 and when the L voltage (second voltage) is applied to the reference electrode 5. Thus, similarly to Embodiment 1, this embodiment can prevent degradation of the display quality caused by the variation in the speed of movement of the conductive liquid 16 due to differences in polarity between the applied voltages.

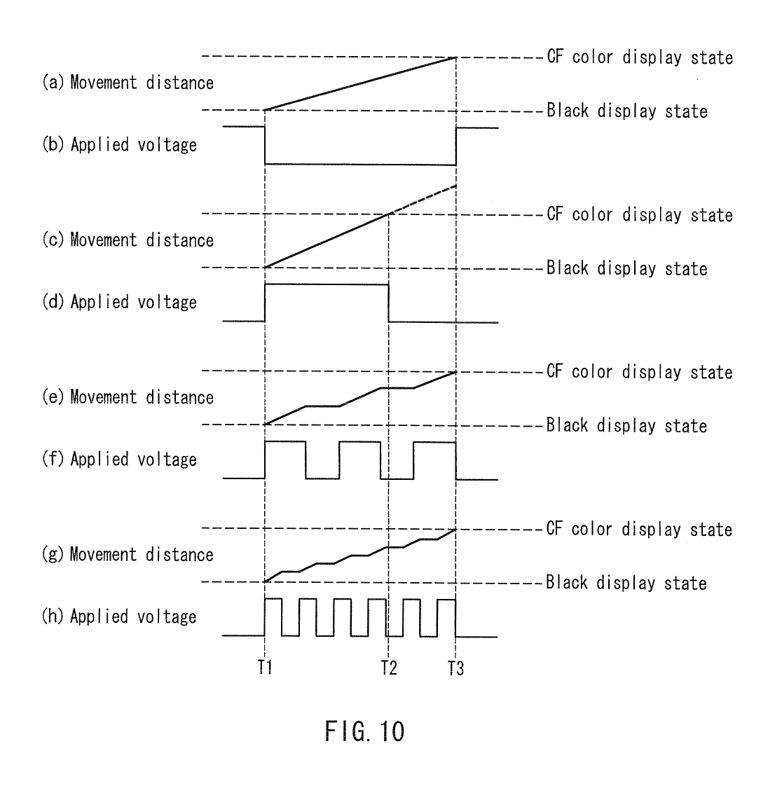

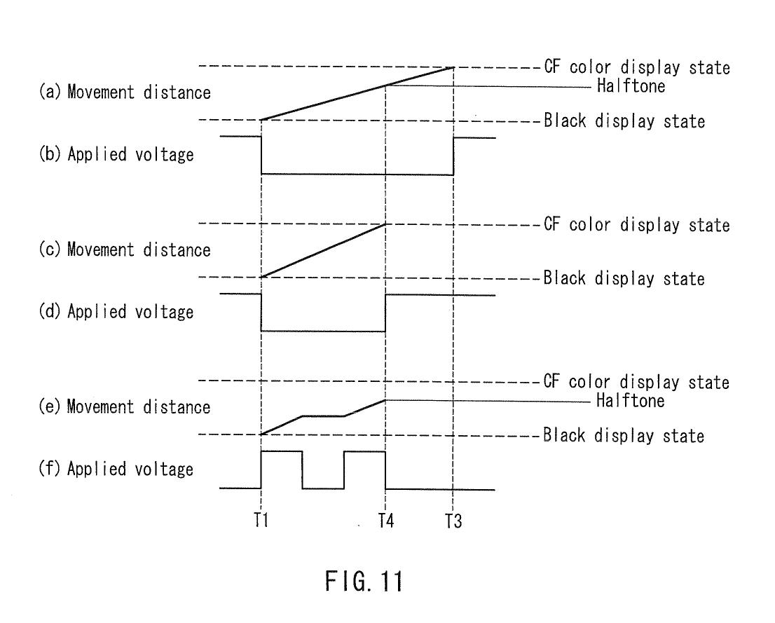

Hereinafter, an operation of the image display apparatus 1 of this embodiment will be described in detail with reference to FIGS. 10 and 11 as well as FIG. 9. The following description mainly refers to the application of the voltage to the signal electrodes 4 to prevent degradation of the display quality in this embodiment. Moreover, although the display device performs the black display by moving the conductive liquid 16 toward the reference electrode 5 and the CF color display by moving the conductive liquid 16 toward the scanning electrode 6, the CF color display will be described as an example in the following (the same is true for modified examples 1 and 2, as will be described later).

FIG. 10 is a diagram for explaining an operation example of the display device shown in FIG. 9. FIGS. 10(a) to 10(h) are diagrams for explaining the relationship between the movement distance of the conductive liquid and the applied voltage to the signal electrode.

First, the full CF color display as a result of the movement of the entire conductive liquid 16 toward the scanning electrode 6 will be described with reference to FIG. 10.

As shown in FIGS. 10(a) and 10(b), when the polarity of the applied voltage to the signal electrodes 4 with respect to the scanning electrode 6 is a negative polarity, the conductive liquid 16 is moved in the direction from the reference electrode 5 to the scanning electrode 6 in accordance with the applied voltage to the signal electrodes 4 between time T1 and time T3. Thus, the display color of each pixel is changed from the black display to the CF color display.

On the other hand, as shown in FIGS. 10(c) and 10(d), when the polarity of the applied voltage to the signal electrodes 4 with respect to the scanning electrode 6 is a positive polarity, the conductive liquid 16 is moved in the direction from the reference electrode 5 to the scanning electrode 6 in accordance with the applied voltage to the signal electrodes 4 between the time T1 and time T2, since the speed of movement of the conductive liquid 16 is faster in the positive polarity than in the negative polarity. Thus, the display color of each pixel is changed from the black display to the CF color display. Accordingly, when the signal voltage Vd of the same magnitude is applied to the signal electrodes 4, the time the black display is changed to the CF color display differs depending on the polarity.

In this embodiment, e.g., as shown in FIGS. 10(e) and 10(f), when the polarity of the applied voltage to the signal electrodes 4 with respect to the scanning electrode 6 is the positive polarity, a pause in which no voltage is applied is made in a period during which the signal voltage Vd is applied to the signal electrodes 4 (i.e., the selected period). Specifically, there are two pauses between the time T1 and the time T3, as shown in FIG. 10(f). Thus, similarly to the negative polarity, the display color can be changed to the CF color display at the time T3, as shown in FIG. 10(e).

Moreover, there are five pauses between the time T1 and the time T3, as shown in FIG. 10(h). Thus, similarly to the negative polarity, the display color can be changed to the CF color display at the time T3, as shown in FIG. 10(g). By increasing the number of pauses, the behavior of the conductive liquid 16 can be made closer to that in the negative polarity.

Next, an operation for performing the halftone display will be described with reference to FIG. 11.

FIG. 11 is a diagram for explaining another operation example of the display device shown in FIG. 9. FIGS. 11(a) to 11(f) are diagrams for explaining the relationship between the movement distance of the conductive liquid and the applied voltage to the signal electrode.

As shown in FIGS. 11(a) and 11(b), when the polarity of the applied voltage to the signal electrodes 4 with respect to the scanning electrode 6 is a negative polarity the conductive liquid 16 is moved in the direction from the reference electrode 5 to the scanning electrode 6 in accordance with the applied voltage to the signal electrodes 4 between the time T1 and the time T3, as shown in FIGS. 10(a) and 10(b). Thus, the display color of each pixel is changed from the black display to the CF color display. In the negative polarity, as shown in FIGS. 11(c) and 11(d), when the application of the signal voltage Vd that has started from the time T1 stops, e.g., at time T4, the halftone display can be performed in accordance with the movement distance of the conductive liquid 16 toward the scanning electrode 6.

As shown in FIGS. 11(e) and 11(f), when the polarity of the applied voltage to the signal electrodes 4 with respect to the scanning electrode 6 is a positive polarity, a pause is made as in the case of FIG. 10(f) or 10(h). Specifically, there is a pause between the time T1 and the time T4, as shown in FIG. 11(f). Thus, similarly to the negative polarity, the same halftone display as that in the negative polarity can be performed at the time T4, as shown in FIG. 11(e).

With the above configuration, this embodiment can have the effects comparable to those of Embodiment 1. In this embodiment, the application time of the voltage applied to the signal electrodes 4 within the selected period (predetermined period) is changed, so that the amount of the voltage applied to the signal electrodes 4 is changed when the H voltage (first voltage) is applied to the reference electrode 5 and when the L voltage (second voltage) is applied to the reference electrode 5, thereby preventing degradation of the display quality caused by the variation in the speed of movement of the conductive liquid 16.

### Modified Example 1 of Embodiment 2

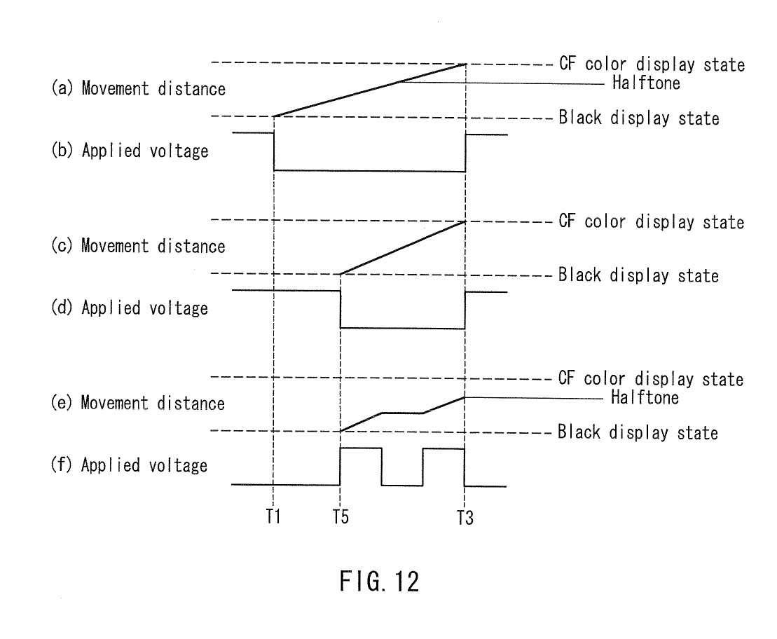

FIG. 12 is a diagram for explaining an operation example in a modified example of the display device shown in FIG. 9. FIGS. 12(a) to 12(f) are diagrams for explaining the relationship between the movement distance of the conductive liquid and the applied voltage to the signal electrode. In FIG. 12, the modified example 1 mainly differs from Embodiment 2 in that the application of the voltage to the signal electrodes in every gradation ends at the same timing. The same components as those of Embodiment 2 are denoted by the same reference numerals, and the explanation will not be repeated.

In the modified example 1, as shown in FIGS. 12(a) and 12(b), when the polarity of the applied voltage to the signal electrodes 4 with respect to the scanning electrode 6 is a negative polarity, the conductive liquid 16 is moved in the direction from the reference electrode 5 to the scanning electrode 6 in accordance with the applied voltage to the signal electrodes 4 between the time T1 and the time T3, as shown in FIGS. 10(a) and 10(b). Thus, the display color of each pixel is changed from the black display to the CF color display.

In the negative polarity, as shown in FIGS. 12(c) and 12(d), the application of the signal voltage Vd starts, e.g., from time T5 and stops at the time T3, so that the halftone display can be performed in accordance with the movement distance of the conductive liquid 16 toward the scanning electrode 6.

As shown in FIGS. 12(e) and 12(f), when the polarity of the applied voltage to the signal electrodes 4 with respect to the scanning electrode 6 is a positive polarity, a pause is made as in the case of FIG. 10(f) or 10(h). Specifically, there is a pause between the time T5 (from which the application of the signal voltage Vd has started) and the time T3, as shown in FIG. 12(f). Thus, similarly to the negative polarity, the same halftone display as that in the negative polarity can be performed at the time T3, as shown in FIG. 12(e).

With the above configuration, the modified example 1 can have the effects comparable to those of Embodiment 2. In the modified example 1, the arrival time of the conductive liquid 16 at the intended position can coincide in every gradation including the halftone regardless of the polarity, and the display quality can be improved.

### Modified Example of Embodiment 2

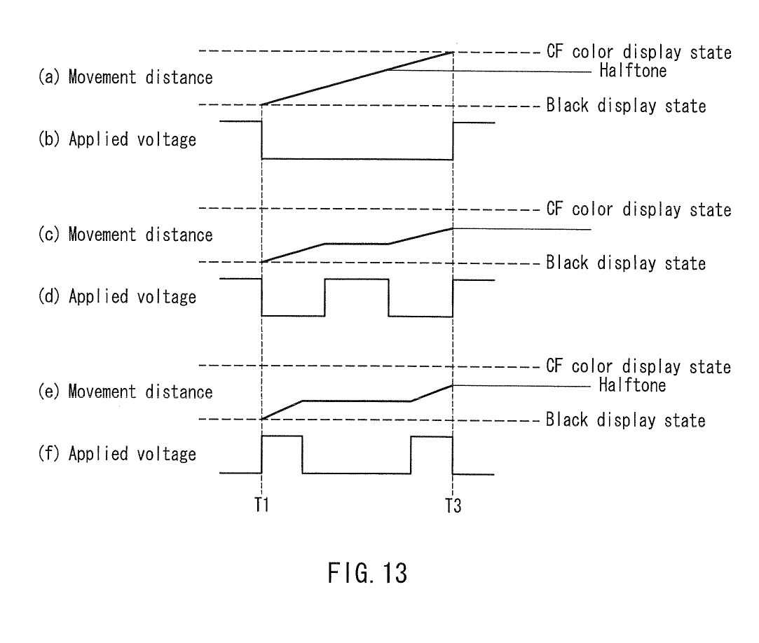

FIG. 13 is a diagram for explaining an operation example in another modified example of the display device shown in FIG. 9. FIGS. 13(a) to 13(f) are diagrams for explaining the relationship between the movement distance of the conductive liquid and the applied voltage to the signal electrode. In FIG. 13, the modified example 2 mainly differs from Embodiment 2 in that the application of the voltage to the signal electrodes in every gradation starts and ends at the same timing. The same components as those of Embodiment 2 are denoted by the same reference numerals, and the explanation will not be repeated.

In the modified example 2, as shown in FIGS. 13(a) and 13(b), when the polarity of the applied voltage to the signal electrodes 4 with respect to the scanning electrode 6 is a negative polarity, the conductive liquid 16 is moved in the direction from the reference electrode 5 to the scanning electrode 6 in accordance with the applied voltage to the signal electrodes 4 between the time T1 and the time T3, as shown in FIGS. 10(a) and 10(b). Thus, the display color of each pixel is changed from the black display to the CF color display.

In the negative polarity, as shown in FIG. 13(d), the application of the signal voltage Vd starts from the time T1, and there are, e.g., two pauses between the time T1 and the time T3, so that the halftone display can be performed, as shown in FIG. 13(c).

As shown in FIGS. 13(e) and 13(f), when the polarity of the applied voltage to the signal electrodes 4 with respect to the scanning electrode 6 is a positive polarity, a pause is made as in the case of FIG. 10(f) or 10(h). Specifically, there is a pause between the time T1 (from which the application of the signal voltage Vd has started) and the time T3, as shown in FIG. 13(f). Thus, similarly to the negative polarity, the same halftone display as that in the negative polarity can be performed at the time T3, as shown in FIG. 13(e).

With the above configuration, the modified example 2 can have the effects comparable to those of Embodiment 2. In the modified example 2, the start time of movement of the conductive liquid 16 and the arrival time of the conductive liquid 16 at the intended position can coincide in every gradation including the halftone regardless of the polarity, and the display quality can be improved further.

It should be noted that the above embodiments are all illustrative and not restrictive. The technological scope of the present invention is defined by the appended claims, and all changes that come within the range of equivalency of the claims are intended to be embraced therein.

For example, in the above description, the present invention is applied to an image display apparatus including a display portion that can display color images. However, the present invention is not limited thereto, as long as it is applied to an electric apparatus with a display portion that displays the information including characters and images. For example, the present invention is suitable for various electric apparatuses with display portions such as a personal digital assistant such as an electronic organizer, a display apparatus for a personal computer or television, and an electronic paper.

In the above description, the electrowetting-type display device is used, in which the conductive liquid is moved in accordance with the application of an electric field to the conductive liquid. However, the display device of the present invention is not limited thereto, as long as it is an electric-field-induced display device that can change the display color on the display surface by moving the conductive liquid in the display space with the use of an external electric field. For example, the present invention can be applied to other types of electric-field-induced display devices such as an electroosmotic type, an electrophoretic type, and a dielectrophoretic type.

As described in each of the above embodiments, the electrowetting-type display device is preferred because the conductive liquid can be moved at a high speed and a low drive voltage. Moreover, since three different electrodes are used to move the conductive liquid slidably, the electrowetting-type display device can achieve both a high switching speed of the display color on the display surface and electric power saving more easily than the display device in which the shape of the conductive liquid is changed. In the electrowetting-type display device, the display color is changed with the movement of the conductive liquid. Therefore, unlike a liquid crystal display apparatus or the like, there is no viewing angle dependence. Moreover, since a switching device does not need to be provided for each pixel, a high-performance matrix-driven display device having a simple structure can be achieved at a low cost. Further, the electrowetting-type display device does not use a birefringent material such as a liquid crystal layer. Therefore, it is possible to easily provide a high brightness display device with excellent utilization efficiency of light from the backlight or ambient light used for information display.

In the above description of Embodiment 1, the magnitude of the voltage applied to the signal electrodes within the predetermined period is changed. Moreover, in the above description of Embodiment 2, the application time of the voltage applied to the signal electrodes within the predetermined period is changed. However, the present invention is not particularly limited as long as the amount of the voltage applied to at least one selected from the signal electrodes and both of the reference electrode and the scanning electrode within the predetermined period is changed when the first voltage (H voltage) is applied to the reference electrode and when the second voltage (L voltage) is applied to the reference electrode. For example, Embodiment 1 and Embodiment 2 may be combined.

The above description refers to the transmission type display device including a backlight. However, the present invention is not limited thereto, and may be applied to a reflection type display device including a light reflection portion such as a diffuse reflection plate, a semi-transmission type display device including the light reflection portion along with a backlight, or the like.

In the above description, the signal electrodes are provided on the upper substrate (first substrate) and the reference electrodes and the scanning electrodes are provided on the lower substrate (second substrate). However, the present invention is not limited thereto, and may have a configuration in which the signal electrodes are placed in the display space so as to come into contact with the conductive liquid, and the reference electrodes and the scanning electrodes are provided on one of the first substrate and the second substrate so as to be electrically insulated from the conductive liquid and each other. Specifically, e.g., the signal electrodes may be provided on the second substrate or on the ribs, and the reference electrodes and the scanning electrodes may be provided on the first substrate.

In the above description, the reference electrodes and the scanning electrodes are located on the effective display region side and the non-effective display region side, respectively. However, the present invention is not limited thereto, and the reference electrodes and the scanning electrodes may be located on the non-effective display region side and the effective display region side, respectively.

In the above description, the reference electrodes and the scanning electrodes are provided on the surface of the lower substrate (second substrate) that faces the display surface side. However, the present invention is not limited thereto, and can use the reference electrodes and the scanning electrodes that are buried in the second substrate made of an insulating material. In this case, the second substrate also can serve as a dielectric layer, which can eliminate the formation of the dielectric layer. Moreover, the signal electrodes may be directly provided on the first and second substrates serving as dielectric layers, and thus may be placed in the display space.

In the above description, the reference electrodes and the scanning electrodes are made of transparent electrode materials. However, the present invention is not limited thereto, as long as either one of the reference electrodes and the scanning electrodes, which are arranged to face the effective display regions of the pixels, are made of the transparent electrode materials. The other electrodes that do not face the effective display regions can be made of opaque electrode materials such as aluminum, silver, chromium, and other metals.

In the above description, the reference electrodes and the scanning electrodes are in the form of stripes. However, the shapes of the reference electrodes and the scanning electrodes of the present invention are not limited thereto. For example, the reflection type display device may use linear or mesh electrodes that are not likely to cause a light loss, since the utilization efficiency of light used for information display is lower in the reflection type display device than in the transmission type display device.

In the above description, the signal electrodes are linear wiring. However, the signal electrodes of the present invention are not limited thereto, and can be wiring with other shapes such as mesh wiring.

As described in each of the above embodiments, it is preferable that the shape of the signal electrodes is determined using the transmittance of the reference electrodes and the scanning electrodes that are transparent electrodes. This is because even if the signal electrodes are made of an opaque material, shadows of the signal electrodes can be prevented from appearing on the display surface, and thus a decrease in display quality can be suppressed. The use of the linear wiring is more preferred because the decrease in display quality can be reliably suppressed.

In the above description, the conductive liquid is a potassium chloride aqueous solution, and the signal electrodes include at least one of gold, silver, copper, platinum, and palladium. However, the present invention is not limited thereto, as long as a material that is electrochemically inert to the conductive liquid is used for the signal electrodes that are placed in the display space and come into contact with the conductive liquid. Specifically, the conductive liquid can be, e.g., a material including an electrolyte such as a zinc chloride, potassium hydroxide, sodium hydroxide, alkali metal hydroxide, zinc oxide, sodium chloride, lithium salt, phosphoric acid, alkali metal carbonate, or ceramics with oxygen ion conductivity. The solvent can be, e.g., an organic solvent such as alcohol, acetone, formamide, or ethylene glycol other than water. The conductive liquid of the present invention also can be an ionic liquid (room temperature molten salt) including pyridine-, alicyclic amine-, or aliphatic amine-based cations and fluorine anions such as fluoride ions or triflate.

As described in each of the above embodiments, the aqueous solution in which a predetermined electrolyte is dissolved is preferred for the conductive liquid because the display device can have excellent handling properties and also be easily produced. The signal electrodes of the present invention may be in the passive state including an electrode body composed of a conductive metal such as aluminum, nickel, iron, cobalt, chromium, titanium, tantalum, niobium, or an alloy thereof and an oxide film disposed to cover the surface of the electrode body.

As described in each of the above embodiments, the signal electrodes including at least one of gold, silver, copper, platinum, and palladium are preferred because these metals have a low ionization tendency and make it possible not only to simplify the signal electrodes, but also to reliably prevent an electrochemical reaction between the signal electrodes and the conductive liquid. Thus, the display device can easily prevent a reduction in the reliability and have a long life. Moreover, with the use of the metals having a low ionization tendency, the interfacial tension at the interface between the signal electrodes and the conductive liquid can be relatively small. Therefore, when the conductive liquid is not moved, it can be easily held in a stable state at the fixed position.

In the above description, the nonpolar oil is used. However, the present invention is not limited thereto. For example, air may be used instead of the oil, as long as it is an insulating fluid that is not mixed with the conductive liquid. Moreover, silicone oil or an aliphatic hydrocarbon also can be used as the oil.

As described in each of the above embodiments, the nonpolar oil that is not compatible with the conductive liquid is preferred because the droplets of the conductive liquid move more easily in the nonpolar oil compared to the use of air and the conductive liquid. Consequently, the conductive liquid can be moved at a high speed, and the display color can be switched at a high speed.

In the above description, the black colored conductive liquid and the color filter layer are used to form the pixels of R, G, and B colors on the display surface side. However, the present invention is not limited thereto, as long as a plurality of pixel regions are provided in accordance with a plurality of colors that enable full-color display to be shown on the display surface. Specifically, the conductive liquids with different colors such as RGB, CMY composed of cyan (C), magenta (M), and yellow (Y), or RGBYC also can be used.

In the above description, the color filter layer is formed on the surface of the upper substrate (first substrate) that faces the non-display surface side. However, the present invention is not limited thereto, and the color filter layer may be formed on the surface of the first substrate that faces the display surface side or on the lower substrate (second substrate). Thus, the color filter layer is preferred compared to the use of the conductive liquids with different colors because the display device can be easily produced. Moreover, the color filter layer is also preferred because the effective display region and the non-effective display region can be properly and reliably defined with respect to the display space by the color filter (aperture) and the black matrix (light-shielding layer) included in the color filter layer, respectively.

### INDUSTRIAL APPLICABILITY

The present invention is useful for a display device that can prevent degradation of the display quality caused by a variation in the speed of movement of the conductive liquid due to differences in polarity between the applied voltages, and a high-performance electric apparatus using the display device.

### DESCRIPTION OF REFERENCE NUMERALS

1 Image display apparatus (electric apparatus)

2 Upper substrate (first substrate)

3 Lower substrate (second substrate)

4 Signal electrode

5 Reference electrode

6 Scanning electrode

7, 7′ Signal driver (signal voltage application portion)

8, 8′ Reference driver (reference voltage application portion)

9, 9′ Scanning driver (scanning voltage application portion)

10 Display device

11 Color filter layer

11r, 11g, 11b Color filter (aperture)

11s Black matrix (light-shielding layer)

13 Dielectric layer

14a, 14b Rib (partition)

16 Conductive liquid

17 Oil (insulating fluid)

S Display space

P Pixel region

P1 Effective display region

P2 Non-effective display region

1. A display device that comprises a first substrate provided on a display surface side, a second substrate provided on a non-display surface side of the first substrate so that a predetermined display space is formed between the first substrate and the second substrate, an effective display region and a non-effective display region that are defined with respect to the display space, and a conductive liquid sealed in the display space so as to be moved toward the effective display region or the non-effective display region, and that is capable of changing a display color on the display surface side by moving the conductive liquid, wherein the display device comprises:
a signal electrode that is placed in the display space so as to come into contact with the conductive liquid;
a reference electrode that is provided on one of the first substrate and the second substrate so as to be electrically insulated from the conductive liquid and to be located on one of the effective display region side and the non-effective display region side; and
a scanning electrode that is provided on one of the first substrate and the second substrate so as to be electrically insulated from the conductive liquid and the reference electrode and to be located on the other of the effective display region side and the non-effective display region side, and wherein the reference electrode is configured so that a first voltage or a second voltage can be applied thereto, the scanning electrode is configured so that the first voltage or the second voltage can be applied thereto, and when one of the first voltage and the second voltage is applied to the reference electrode, the other voltage is applied to the scanning electrode, and
an amount of voltage applied to at least one selected from the signal electrode and both of the reference electrode and the scanning electrode within a predetermined period is changed when the first voltage is applied to the reference electrode and when the second voltage applied to the reference electrode.

2. The display device according to claim 1, wherein a plurality of the signal electrodes are provided along a predetermined arrangement direction, and
a plurality of the reference electrodes and a plurality of the scanning electrodes are alternately arranged so as to intersect with the plurality of the signal electrodes, and
wherein the display device comprises:
a signal voltage application portion that is connected to the plurality of the signal electrodes and applies a signal voltage in the predetermined voltage range to each of the signal electrodes in accordance with information to be displayed on the display surface side;
a reference voltage application portion that is connected to the plurality of the reference electrodes and applies one of a selected voltage and a non-selected voltage to each of the reference electrodes, the selected voltage allowing the conductive liquid to move in the display space in accordance with the signal voltage and the non-selected voltage inhibiting a movement of the conductive liquid in the display space; and
a scanning voltage application portion that is connected to the plurality of the scanning electrodes and applies one of a selected voltage and a non-selected voltage to each of the scanning electrodes, the selected voltage allowing the conductive liquid to move in the display space in accordance with the signal voltage and the non-selected voltage inhibiting a movement of the conductive liquid in the display space.

3. The display device according to claim 1, wherein magnitude of the voltage applied to at least one selected from the signal electrode and both of the reference electrode and the scanning electrode within the predetermined period is changed so that a potential difference between the signal electrode and the reference electrode or between the signal electrode and the scanning electrode when the first voltage is applied to the reference electrode differs from a potential difference between the signal electrode and the reference electrode or between the signal electrode and the scanning electrode when the second voltage is applied to the reference electrode.

4. The display device according to claim 3, wherein the magnitude of the voltage applied to the signal electrode within the predetermined period is changed so that a potential difference between the signal electrode and the reference electrode or between the signal electrode and the scanning electrode when the first voltage is applied to the reference electrode differs from a potential difference between the signal electrode and the reference electrode or between the signal electrode and the scanning electrode when the second voltage is applied to the reference electrode.

5. The display device according to claim 1, wherein an application time of the voltage applied to the signal electrode within the predetermined period is changed when the first voltage is applied to the reference electrode and when the second voltage is applied to the reference electrode.

6. The display device according to claim 1, wherein a plurality of pixel regions are provided on the display surface side, the plurality of the pixel regions are located at each of the intersections of the signal electrodes and the scanning electrodes, and
the display space in each of the pixel regions is partitioned by a partition.

7. The display device according to claim 6, wherein the plurality of the pixel regions are provided in accordance with a plurality of colors that enable full-color display to be shown on the display surface side.

8. The display device according to claim 1, wherein an insulating fluid that is not mixed with the conductive liquid is movably sealed in the display space.

9. The display device according to claim 1, wherein a dielectric layer is formed on the surfaces of the reference electrode and the scanning electrode.

10. The display device according to claim 1, wherein the non-effective display region is defined by a light-shielding layer that is provided on one of the first substrate and the second substrate, and
the effective display region is defined by an aperture formed in the light-shielding layer.

11. An electric apparatus comprising a display portion that displays information including characters and images, wherein the display portion comprises the display device according to claim 1.
